(19) United States
(12) Patent Application Publication
(10) Pub. No.: US 2009/0237651 A1
(43) Pub. Date: Sep. 24, 2009

(54) Verifiable hand cleansing formulation and method

(76) Inventors: Douglas C Arndt, Ventura, CA (US); Franklin D. Hwang, Glendora, CA (US)

Correspondence Address: Infection prevention system, inc, 1743 S. grand ave., Glendora, CA, 91740, US

(21) Appl. No.: 12/311,089

(22) PCT Filed: Oct. 30, 2007
(86) PCT No.: PCT/US07/22843

§ 371 Date: Mar. 18, 2009

Related U.S. Application Data
(60) Provisional application No. 60/855,763, filed on Nov. 1, 2006.
(60) Provisional application No. 60/855,766, filed on Nov. 1, 2006.

(51) Int. Cl. G01J 1/10; C11D 17/00

(52) U.S. Cl. 356/229; 510/138

(57) ABSTRACT

A hand cleansing formulation in the form of a soap/disinfectant (liquid, foam, cream or powder) in solution contains a marker agent (e.g., fluorescent or phosphorescent agent(s)) aggregated with a non-marker binder material. By vigorously scrubbing the hands together, as required by a proper hand washing procedure, the aggregates are dissociated to allow the measurement of the fluorescence/phosphorescence intensity under an activation light source, i.e., UV, IR. This intensity measurement directly relates to the thoroughness of the hand scrubbing steps, thereby allowing the thoroughness of hand scrubbing during a hand washing event to be judged and monitored.

### RELATED APPLICATIONS

This application claims the benefit of U.S. Provisional Applications No. 60/855,763 filed on Nov. 1, 2006 and 60/855,766 filed on Nov. 1, 2006. The contents of said applications are incorporated herein by reference.

### TECHNICAL FIELD

This application relates to hand cleansing formulations, such as soaps and disinfectants, which are capable of removing, destroying, neutralizing and/or inhibiting the growth of pathogenic microorganisms and more particularly to cleansing formulations which permit verification of the thoroughness of the hand washing procedure.

### BACKGROUND ART

Hand hygiene is critical in preventing infectious microorganisms, i.e., germs, like methicillin-resistant Staphylococcus aureus (MRSA), vancomycin-resistant Enterococcus (VRE), Clostridium difficile, E. Coli, salmonella, etc., from propagating in healthcare settings such as hospitals and urgent care facilities. Hand hygiene is also very important in the restaurant and food preparation industries along with prevention of epidemics in public health.

It has been published that some 80,000 patients die annually due to infections contracted in the U.S. hospitals and many more suffer serious complications due to infections resulting in an estimated cost around $36 billion dollars to the health insurance companies and hospitals. Propagation of germs by the health workers from one patient to another is a primary cause of raging infection problems in the hospitals. All evidences and studies have established that proper hand washing procedure is a major step for greatly reducing the infections in healthcare settings. Unfortunately, even under strict monitoring, it is estimated that only 60% of the healthcare workers adhere to an appropriate hand washing procedure and frequency, under monitored conditions, while less than 44% will comply if only education/training without monitoring is instituted. With intense education and training of staffs, the compliance to frequent and proper hand washing is still low (less than 44% without close monitoring and around 60% under constant observation). One of the key issues of non-compliance is inconvenience due to the location of wash basins as well as pressing workloads.

Furthermore, many of the hand washing processes performed are ineffective due to inefficient antibacterial soap, incomplete hand scrubbing and rinsing or even touching the contaminated water faucet, soap, soap dispenser, sink or hand dryer to render the hand washing effort null.

In the food industry, the statistics are even worse with many of the workers only casually rinsing their hands after using the rest rooms or handling the raw meats. Introduction of E. coli, salmonella, hepatitis, etc. by unclean hands have caused many cases of food poisoning and out breaks each year. Not only personal loss and suffering are the results, but also economic loss due to sharp decline of business and long term brand reputation damage.

The U.S. Center for Disease Control and Prevention (CDC), after extensive research studies and field trials, has highly recommended that hand scrubbing for 15-20 seconds with soap is essential to remove contaminants and allow the soap or antimicrobial agents within the soap to kill off the transient and residential germs on hands. While monitoring the frequency of hand washing, via human observers, may be relatively easy, recording the vigorous hand scrubbing required for verification purposes, is next to impossible. Consequently, at the present, there is no effective method of ensuring the effectiveness of hand washing for hospitals or food processing facilities to utilize.

As an example, many hospitals employ nurses to observe and record the hand washing frequency and elapsed time of hand washing process of their staff. The recorded data is unreliable at best since the time one spends in front of a wash basin does not automatically translate to thorough hand scrubbing, thus effective hand washing. Also some hospitals rely on soap used as an indicator of the amount of hand washing by it's staff. This approach only provides a measure of the total number of hand washings done during a period of time, but there is no gage of the effectiveness of each hand washing event.

Several prior art patents/publications have described the use of soap or other disinfectant solutions that can change color or physical property as a function of time after it has been dispensed on to the hands. See, for example, U.S. Pat. No. 7,053,029, U.S. Patent Applications Nos. 20060264346, 20050233919, 20050233918, 20050090414 and Foreign Patents/Applications FR2717184, FR2805162, WO9629047, WO9709957. These systems can only provide a time indication that the soap or disinfectant has been dispensed onto the hands rather than a specific measurement of the amount of hand scrubbing to remove the contaminants and killing off the germs. Other prior art patents (U.S. Pat. Nos. 5,900,067 and 6,524,390) introduce a fluorescent agent into the soap solution and examine the hands after rinsing to see whether any fluorescence is left behind to assure the hands no longer have soap left over. This approach also does not provide a measure of the effectiveness of any scrubbing action during the hand washing process. U.S. Pat. Nos. 6,038,331 and 6,970,574 utilize a pattern recognition method to determine the soap coverage on a person's hands as a measure of the effectiveness of hand washing process. Again, this provides only an inference instead of a direct measurement of the amount of hand scrubbing that has taken place.

Another set of prior art patents/publications (like U.S. Pat. Nos. 6,975,231, 6,727,818, 6,392,546, 6,236,317, 5,966,753, 5,945,910, 5,793,653, 5,610,589, 5,202,666, and WO03082351) that record who has performed a hand washing procedure by determining the extent of soap and rinse water dispensed after a time period. However, none of these systems actually monitor the hand scrubbing phase after the soap disinfectant has been dispensed, nor do any of these prior art references determine whether the scrubbing complies with a proper hand hygiene procedure.

We have discovered a hand cleansing formulation, that may be a soap or other disinfectant solution, which will allow measurement and verification during the hand hygiene procedure as to whether the amount of prescribed hand scrubbing, such as that prescribed by the CDC hand washing guidelines, has been adhered to. By incorporating this invention with appropriate optical and electronic means, a true and accurate hand washing monitoring system can be constructed to provide the surveillance required in hospitals and food processing/delivery entities to minimize cross infections from their staffs due to improperly washed hands.

### SUMMARY OF THE INVENTION

A hand cleansing and use evaluation permitting formulation, in accordance with the present invention, encompasses a cleansing compound, in the form of a soap disinfectant, which is capable of cleansing a user's hands by removing, destroying, neutralizing or inhibiting the growth of pathogenic microorganisms through a scrubbing action with or without the presence of water. A marker agent, in the form of a fluorophor/phosphor, dye, etc. (Table 1) visibly detectable when exposed to light in the visible or non-visible spectrum (i.e., UV or IR), is aggregated with a non-marker binder with the binder being capable of releasing the marker when the cleansing formulation is subjected to the scrubbing action. The detectability of the marker is noticeably increased when released from the binder as compared to its detectability when aggregated with the binder. The marker's increase in detectability when disassociated from the binder is preferably by a factor of 2+ and most preferably substantially, i.e., by a factor of one or more orders of magnitude.

The resultant increase in the marker's visibility is directly correlated to the amount of the user's hand scrubbing action leading to an assessment of whether or not an appropriate hand hygiene has been achieved. By incorporating this invention with appropriate electronics and optics, a true and accurate hand washing monitoring system can be constructed to provide the surveillance required in hospitals and food processing/delivery entities to minimize cross infections from staff due to improperly washed hands.

The invention also encompasses a method of using the unique cleansing formulation to monitor the hand washing protocol and verify that the protocol has passed a desired hand hygiene standard. The invention may best be understood by reference to the following description taken in conjunction with the appended drawings.

### BRIEF DESCRIPTION OF THE DRAWINGS

FIG. 1 is a perspective view of a manually activated soap/disinfectant dispenser and a simplified hand washing monitoring or verification module apparatus suitable for use with the present invention positioned above a typical wash basin;

FIG. 2 demonstrates the hands undergoing a washing action at the site of FIG. 1;

FIG. 3 illustrates the disassociated marker present on the hands and being inspected by the monitoring apparatus of FIG. 1 for verification that proper hygiene has been followed;

FIG. 4 shows the hands being rinsed in the wash basin of FIG. 1;

FIG. 5 shows the hands being presented to the monitor of FIG. 1 after the rinsing process;

FIG. 6 shows the hands being dried under the dryer of FIG. 2 after passing the rinsing inspection; and

FIG. 7 is an enlarged perspective view of the simplified hand hygiene verification module of FIG. 1.

### DETAILED DESCRIPTION OF THE PREFERRED EMBODIMENTS

### Overview

In the “Background of the Invention” section, the necessity of hand washing for participants in the health care and food preparation fields and the necessity of monitoring the thoroughness of hand washing steps has been amply stated. The CDC Guideline for Hand Washing and Hospital Environmental Control, 1985 notes at page 9 recommends “for routine hand washing, a vigorous rubbing together of all surfaces of lathered hands for at least 10 seconds, followed by thorough rinsing under a stream of water”. The Association for Professionals in Infection Control and Epidemiology (APIC) also issued guideline for hand washing and hand antisepsis in healthcare setting (1995), which recommends similar time period of hand scrubbing to remove or destroy transient microorganisms.

As pointed out in the “Summary of the Invention” section, this invention, in broad terms, comprises two principal parts:

(a) a cleansing compound capable of cleansing a user's hands by removing, destroying, neutralizing or inhibiting the growth of pathogenic microorganisms through a scrubbing action against the skin with or without the presence of water; and

b) a marker agent visibly detectable when exposed to light having a wavelength in the visible or non-visible spectrum, the marker being aggregated with a non-marker binder, which is capable of releasing the marker when the cleansing formulation is subject to the scrubbing action, the detectability of the marker being noticeably increased when released from the binder as compared to its detectability when aggregated with the binder. The term “noticeably increased” means that sufficient marker has become disassociated from the binder to insure that the scrubbing action has substantially complied with the CDC or comparable guidelines.

The combination of these two parts results in a effective cleansing formulation which allows the hand washing procedure to be monitored to ensure that a selected hand hygiene protocol has been followed.

The mechanical friction produced during vigorous hand scrubbing causes the aggregates of the binder/marker agent to disintegrate thereby freeing or releasing the marker from the binder providing an increase in the intensity of the light emitted by the marker. The increased intensity can be quantitatively measured and correlated with the thoroughness of the scrubbing action.

In summary, the measurements of the light emitted (and reflected) from the user's hands during the washing protocol distinguish between acceptable and unacceptable levels of the disassociated marker present on the hands allowing a judgment to be made on whether or not sufficient scrubbing and rinsing has taken place.

### Discussion of the Drawings

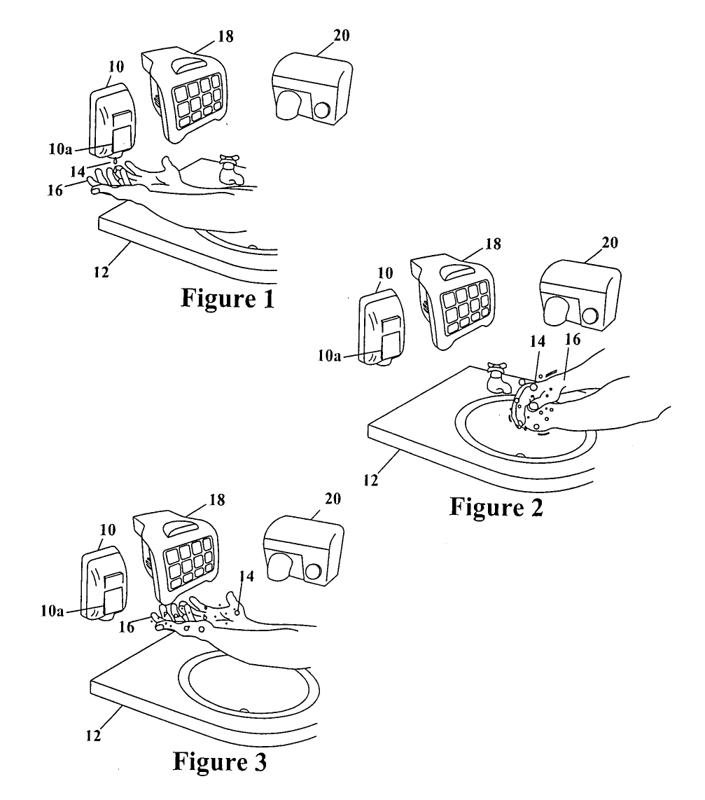

Referring to FIGS. 1-6 a soap (or disinfectant) dispenser 10, positioned above a wash basin 12, has been manually activated via tab 10a to dispense a given quantity of the cleansing formulation 14 including a marker onto a user's hands 16. The user, such as a hospital staff person, scrubs his/her hands together as is illustrated in FIG. 2. The scrubbing action, as discussed previously, disassociates the marker 14 from the binder as is illustrated in FIG. 3.

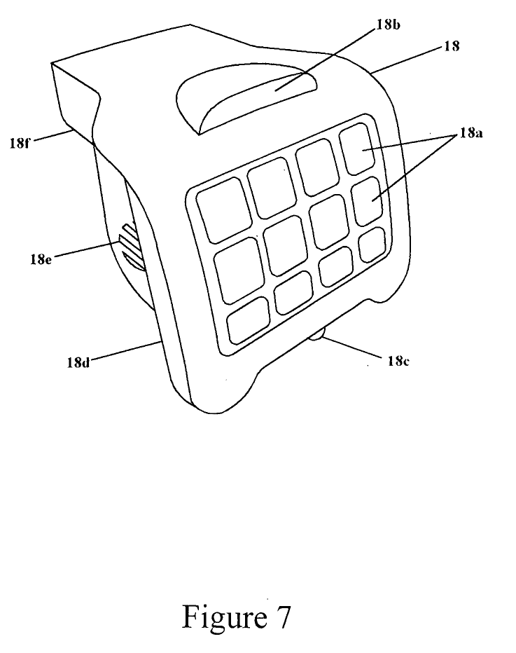

A hand hygiene verification module 18 includes LCD displays 18a and 18b, an individual staff personnel sensor 18c, an undercut region 18d for housing a light source, such as a U.V. light (not shown), for focusing the light onto the hands, a light sensor, such as photovoltaic cell (not shown), for measuring the quantity of light radiating from the hands and a speaker 18e for providing an audible message to the user, e.g., scrub your hands for fifteen seconds. See FIG. 7.

FIG. 3 illustrates the scrubbed hands being exposed to the verification module where the light emitted from the disassociated marker 14 present on the hands is being quantitatively measured by the monitor 18. A measurement above a predetermined level signifies that sufficient marker has been disassociated from the binder to ensure that the hand washing routine has met or exceeded an acceptable standard and a measurement below that level represents a failed routine. In the latter case the user may be informed by the speaker to repeat the hand washing step.

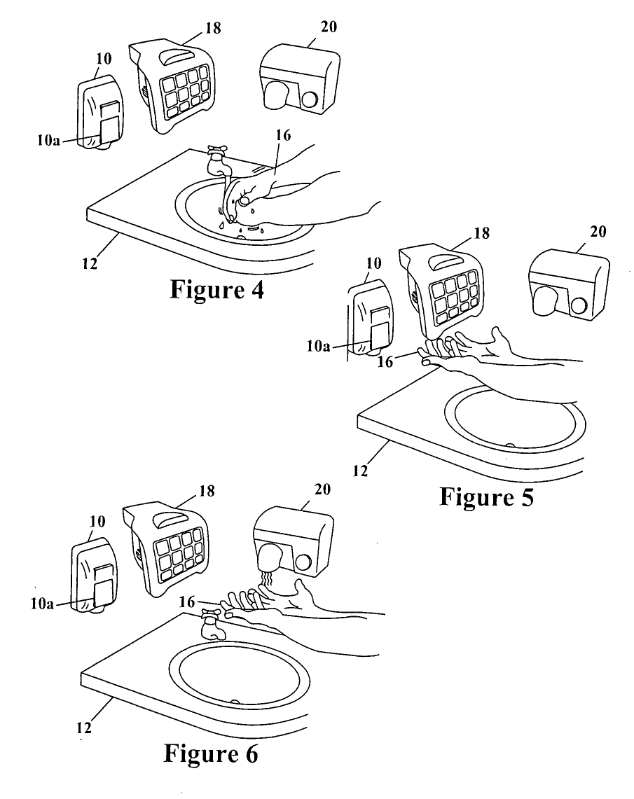

FIGS. 4 and 5 illustrate the hands being rinsed and subsequently exposed to the monitor 18, respectively, for verification that the soap has been removed. FIG. 6 illustrates the use of a conventional blow dryer 20 to dry the hands to remove moisture therefrom.

The measurements taken by the monitor 18 can be correlated with each individual user via the sensor 18c reading a badge worn by the user via an IR or RF signal, unique to the user in a conventional manner. The measurements can then be transmitted to a suitable processing center for subsequent use.

Markers and binders for hand cleansing formulations

| | |
|---|---|
| MARKERS | BINDERS |

1. Fluorescent Mineral Pigments

| | | |
|---|---|---|
| 1 | Zinc Sulfide with Cu doping | Lactose/cellulose/ |
| | | Hydroxypropylmethylcellulose |
| | | (HPMC) |
| 2 | ZnS with Sr doping | Lactose/cellulose/HPMC |
| 3 | ZnS with Mn doping | Lactose/cellulose/HPMC |
| 4 | ZnS with Al doping | Lactose/cellulose/HPMC |
| 5 | BeAl₂O₃; CaAl₂O_{4;} MgAl₂O₄; | Lactose/cellulose/HPMC |
| | SrAl2O4; BaAl₂O₄ | |
| 6 | BeSiO₄; Ca₂SiO_{4;} Mg₂SiO₄; | Lactose/cellulose/HPMC |
| | SrAl2O4; Ba₂SiO₄ | |
| 7 | BeCO₃; CaCO₃; MgCO₃; | Lactose/cellulose/HPMC |
| | BaCO₃; SrCO₃ | |
| 8 | BeB₂O₃; CaB₂O₃; MgB₂O₃; | Lactose/cellulose/HPMC |
| | SrB₂O₃; BaB₂O₃ | |
| 9 | BeMoO₄; CaMoO₄; MgMoO₄; | Lactose/cellulose/HPMC |
| | BaMoO₄; SrMoO₄ with Al, Y, | |
| | Zr, Eu, Zn dopants | |
| 10 | Inorganic oxysulphides like | Polyvinylpyrollidone |
| | UC-3, UC-8 and UC-60 | (PVP) or PVP-polyvinylalcohol |
| | From Artemis Ltd. | (PVA) copolymer |
| 11 | Fuchsite | Lactose/cellulose/HPMC |
| 12 | Aluminum potassium silicate | Sodium carboxymethyl- |
| | | cellulose/lactose |
| 13 | Calcium carbonate/titanium | Guar gum/corn starch |
| | dioxide | |

2. Dyed Polymers or Plastics

| | | |
|---|---|---|
| 14 | AIT-4466 Invisible yellow from | Gelatin/starch |
| | Dayglo | |
| 15 | D034 Yellow from Dayglo | Gelatin/starch |
| 16 | IPO-13 red, IPO-15 orange, | Gelatin/starch |
| | IPO-18 green and IPO-19 blue | |
| | from Dayglo | |
| 17 | PF-00 invisible blue, PF-01 | Gelatin/starch |
| | invisible orange, PF-RT | |
| | invisible red, PF-07 invisible | |
| | blue-white, PF-08 invisible | |
| | bright white, PF-09 invisible | |
| | violet from Risk Reactor | |
| 18 | PSP, MDP and MTC series of | Gelatin/starch |
| | dyes from Spectra System | |
| | Corporation. | |

3. Fluorescent Dyes

| | | |
|---|---|---|
| 19 | Spectra White PD from | Lactose/cellulose/HPMC |
| | Spectra Colors | |
| 20 | Coumarin 6 | Lactose/cellulose/HPMC |
| 21 | Coumarin 4 | Lactose/cellulose/HPMC |
| 22 | zinc-8-quinolinolate | PVA/PVP |
| 23 | 2-(2-hydroxyphenyl) | Lactose/cellulose/HPMC |
| | benzothiazole | |
| 24 | Ferric ferrocyanide | Lactose/cellulose/HPMC |
| | (Prussian Blue) | |
| 25 | Rhodamine Base | Mannitol/acacia gum |
| 26 | DayGlo DG-20 Violet #2 | Carageenan/gelatin |

4. Phosphorescent Dyes

| | | |
|---|---|---|
| 27 | CaS | Lactose/cellulose/HPMC |
| 28 | Carbazole | Lactose/cellulose/HPMC |

5. Colored Markers

| | | |
|---|---|---|
| 29 | Nichkel dimethylglyoxime | Polyvinylpyrollidone |
| | | (PVP) or PVP- |
| | | polyvinylalcohol copolymer |
| 30 | Cr(OH)₃ | Lactose/cellulose/HPMC |
| 31 | Zinc phthlocynine | Lactose/cellulose/HPMC |
| 32 | Copper phthlocynine | Lactose/cellulose/HPMC |

6. Reflective Markers

| | | |
|---|---|---|
| 33 | Silver polyester flakes | Lactose/cellulose/HPMC |
| 34 | Aluminum Flakes and/or | Lactose/cellulose/HPMC |
| | powder | |
| 35 | Glass micro-beads | Lactose/cellulose/HPMC |
| 36 | barium sulfate | Lactose/cellulose/HPMC |
| 37 | alumina | Lactose/cellulose/HPMC |
| 38 | magnesium carbonate | Lactose/cellulose/HPMC |

7. Anti-Stoke's Pigment

| | | |
|---|---|---|
| 39 | Epolight A225 | PVP or PVA |
| | From Epolin, Inc. | |

As discussed previously, the marker is joined to the non-marker binder to form aggregates or agglomerates so that the detectability of the marker is relatively low until disassociated from the binder. The dimensions of the aggregates or agglomerates (e.g., largest measurement) are within the range of about five microns to several hundred (e.g., three hundred) microns and are preferably within the range of about five to one hundred microns and most preferably are about ten to fifty microns. The agglomerates can be bound together mechanically and/or electrostatically. Preferably the marker and/or the binder is substantially water-insoluble.

Markers and particularly of the fluorescent and phosphorescent type in pigment form are substantially non-staining to the skin whether dispersed in water, alcohol, glycol, glycerol, surfactants and oils. Many of the water-insoluble binders may be hydrated and softened with the solution to facilitate disintegration of the aggregrate during the scrubbing action.

As is also apparent from the table, the binder may be one or more of the following: lactose, microcrystalline cellulose, hydroxypropylmethylcellulose, polyvinyl alcohol, mannitol, alkylated celluloses, polyvinylpyrollidone (PVP), copolymers of PVP using other resins, and alkylated PVPs.

The marker may also contain one or more anti-Stokes pigments. See item 39 in the table.

Where the pigment is a mineral it may be selected from one or more of the group consisting of Zinc sulfides dope with copper, strontium, manganese; calcium sulfides, alkaline earth aluminates, alkaline earth silicates, basic metallo-phosphates, alkaline earth oxides, alkaline earth sulfides, alkaline earth carbonates, alkaline earth borates, alkaline earth tungstates, alkaline earth molybdates with many dopants (such as aluminum, yttrium, zirconium, europium, zinc) to constitute the mineral as phosphors (typical usages like in color cathode ray tubes and light emitting diodes), inorganic oxysulphides like UC-3 red, UC-8 green and UC-60 blue from Artemis Ltd. (London, U.K.).

The pigment may also be a noble or rare earth metal in the colloidal state or as nanoparticle.

Where the chosen marker is a water-insoluble fluorescent in the form of a dyed polymer or plastic, it may include organic dyes dissolved in organic polymeric resins supplied from Dayglo Color Corporation (Cleveland, Ohio), Magruder Color Corporation (Elizabeth, N.J.) and others such as invisible fluorescent pigments like AIT-4466 Invisible Yellow, D034 Yellow, IPO-13 red, IPO-15 orange, IPO-18 green and IPO-19 blue from Dayglo Color Corporation; PF-00 invisible blue, PF-01 invisible orange, PF-RT invisible red, PF-07 invisible blue-white, PF-08 invisible bright white, PF-09 invisible violet from Risk Reactor; PSP, MDP and MTC series of dyes from Spectra System Corporation (Providence, R.I.).

Some of the fluorescent/phosphorescent dyes will not stain (bond to) human skin when dispersed in water, alcohol, etc. See items 19 to 26 in the table.

The organic molecule forming the fluorescent or phosphorescent dye may have one or more (e.g., 6) carbon rings. See items 20 to 23 in the table. Such an organic dye marker may be selected from one or more of the group consisting of coumarinic compounds, stilbene and its derivatives, pyrene and its derivatives, anthracenes, tetracenes, pentracenes, quinolines, quinones, aryl methanes, naphthacenes, fluoresceins, anilines, thiazoles, oxazoles, pyranines, carbazoles, rhodamines, dansylated compounds, propidiums, biotin derivatives, ethidiums, cyanines, uranines, benzoxazoles, benzothizaoles, succimidyl compounds dialdehydes, quinoids.

The above listed marker agents and binders, suitable for use in this invention, are by way of example only. While not all of the examples have been tested, it is believed that all will provide a satisfactory hand cleansing formulation in accordance with our invention.

### Specific Examples of Fluorescent Markers and The Resulting Data

Two different fluorescent agents and their aggregates are used as specific examples to illustrate the invention in its varying embodiments.

Forty percent by weight of zinc sulfide marker agent (a mineral pigment) is mixed with polyvinypyrollidone (binder) to form an aggregate of 10-100 micron range. Sieving and gentle grinding can be used to reduce the size further toward uniform 10 micron particle size.

The aggregates are mixed into regular ordinary over-the-counter liquid soap (2.5% by weight of the aggregates) from Dial® (White Tea & Vitamin E Pearls) with 0.1% by weight of xanthan gum (thickening agent) added to permit long term uniform suspension of the aggregates in the liquid soap. The aggregates may require prior soaking in water (hydration process) for other brands of liquid soap to facilitate suspension into the liquid soap. Dial is a trademark of Henkel Corporation, Graph Mills, Philadelphia.

A Roscolux #388 color filter (by Rosco Laboratories, Inc., Stanford, Conn.) is used to cover a 1″×2″ photovoltaic cell, which is connected to a voltage signal amplifier for measuring the green-yellow fluorescence generated by zinc sulfide when exposed to 370 nm ultra violet (UV) light. This detection setup is housed in a casing, like module 18 (FIG. 7) looking downward to view the hands presented underneath. The photovoltaic cell panel is surrounded with 6 UV LEDs (peak emission wavelength at 375 nm), and their power supply is modulated at 700 Hz identical to the detection photovoltaic cell. The Roscolux filter has a transmission curve which effectively filters out the actuating UV light while freely passing the induced fluorescence.

Dry hands and wetted hands are presented to this detection setup to establish a base line. Voltage measurements varied with respect to the color of the skin, but mostly the measurements are of less than 100 mV. The darker skin typically will have lower voltage reading due to less stray light reflection from the hands toward the detection photovoltaic panel.

The hands are then wetted with a small amount of water prior to dispensing 2 ml of the formulation for scrubbing. After vigorously scrubbing the hands from palm to palm, between fingers, palm to back of hands for 10 seconds, a voltage measurement of 2-3V is achieved with darker skin actually provides higher voltage readings.

After rinsing of the hands for 10 seconds, a typical measurement of less than 100 mV is again registered.

The same person now goes through the pre-wetting of the hands and dispensing 2 ml of the formulation for the second time. Instead of vigorously scrubbing this time, the person just gently rubs the hands for 10-15 seconds to spread the formulation around the hands evenly. Using the same detection setup; the voltage measurements are typically less than 800 mV (due to the lather having higher reflectivity of stray light). This amply demonstrates that many of the aggregates are not disintegrated to disassociate the zinc sulfide so that it is exposed to the UV light, thus much less of induced green-yellow fluorescence can be detected.

By setting a threshold of 1.0 V, the detection circuitry outlined above can differentiate whether a person has performed vigorous hand scrubbing or not as dictated by the CDC guideline.

A separate set of formulations based on Spectra White PD dye (supplied from Spectra Systems Corporation) is prepared. 10% by weight of the water soluble dye is combined with binder formed by lactose, microcrystalline cellulose and hydroxypropylmethylcellulose. 1% by weight of the dye in aggregates is mixed into liquid foam soap supplied by Medline Industries, Inc., Mundelein, Ill. The much smaller particle size of a few microns allows the formulation to be dispensed through a fine filter as foam. The formulation changes Medline soap's original orange-reddish color to more reddish color. This formulation is filled into a dispenser cartridge supplied by Gojo Industries, Akron, Ohio for manual dispensing.

Using the same detection setup, again the wetted and dry hands are measured first to establish the base line of approximate 100 mV with no formulation dispensed on to the hands.

After dispensing approximately 1.5 ml of the soap solution as foam and vigorously scrubbing the hands for 10 seconds, the fluorescence intensity is consistently measured above 2.5V.

Further trials from gentle scrubbing for 10 to 15 seconds to merely spreading the soap on hands have produced voltage measurements ranging from 500 to 900 mV. Again, by setting a threshold of 1.0V, it will enable the detection setup to determine whether thorough scrubbing of hands has been executed.

Based on this detection setup adding a logic circuit, the system can trigger either audio and/or visual notification to the person undergoing the hand washing procedure whether he/she has done a thorough hand washing job per CDC guideline.

Combining this expanded setup with a method of identifying the person undergoing the hand washing procedure and coupling with a time-date as well as a communication circuitry that skilled artisans can readily design, the system becomes a hand washing monitoring system that will provide the reporting of not only hand washing frequency of each personnel, but also the thoroughness of each hand washing event. This indeed becomes a true hand washing monitoring system a healthcare or food processing entity can use to reliably monitoring and enforcing the hand washing guidelines stipulated by CDC, APIC and many other relevant government agencies.

A novel hand cleansing formulation permitting a proper hand hygiene protocol has been followed along with a method of making that determination. Modifications and perhaps improvements to the invention may occur to those skilled in the art without involving a departure from the spirit and scope of our invention as defined in the appended claims.

What is claimed is:

1. A hand cleansing and use evaluation permitting formulation comprising:
a) a cleansing compound capable of cleansing a user's hand by removing, destroying, neutralizing or inhibiting the growth of pathogenic microorganisms through a hand scrubbing action with or without the presence of water; and
b) a marker agent visibly detectable when exposed to light having a wavelength in the visible or non-visible spectrum, the marker being aggregated with a non-marker binder, the binder being capable of releasing the marker when the cleansing formulation is subject to the scrubbing action, the detectability of the marker being noticeably increased when released from the binder as compared to its detectability when aggregated with the binder.

2. The cleansing formulation of claim 1 wherein the dimension of the aggregates is within the range of about five to several hundred microns.

3. The cleansing formulation of claim 1 wherein the agglomerates are bound together mechanically and/or electrostatically in a solution.

4. The cleansing formulation of claim 1 wherein the marker agent is selected from one or more of the groups consisting of fluorophors or phosphors.

5. The cleansing formulation of claim 4 wherein the fluorescent and/or phosphorescent agent(s) are substantially water-insoluble.

6. The cleansing formulation of claim 5 wherein the binder is substantially water-insoluble.

7. The cleansing formulation of claim 6 wherein water-insoluble binder(s) are hydrated and softened within the solution facilitating disintegration of the aggregate during hand scrubbing steps.

8. The cleansing formulation of claim 1 wherein the binder is selected from one or more of the following: lactose, microcrystalline cellulose, hydroxypropylmethylcellulose, polyvinyl alcohol, mannitol, alkylated celluloses, polyvinylpyrollidone (PVP), copolymers of PVP using other resins, and alkylated PVPs.

9. The cleansing formulation of claim 4 wherein the fluorescent and/or phosphorescent agent(s) are in a pigment form substantially preventing the staining of the human skin.

10. The cleansing formulation of claim 9 wherein the marker further contains one or more anti-Stoke's pigments.

11. The cleansing formulation of claim 9 wherein the pigment is a mineral.

12. The cleansing formulation of claim 11 wherein the mineral is selected from one or more of the group consisting of Zinc sulfides doped with copper, strontium, manganese; calcium sulfides, alkaline earth aluminates, alkaline earth silicates, basic metallo-phosphates, alkaline earth oxides, alkaline earth sulfides, alkaline earth carbonates, alkaline earth borates, alkaline earth tungstates, alkaline earth molybdates with many metal dopants to constitute the mineral as phosphors; also inorganic oxysulphides like UC-3 red, UC-8 green and UC-60 blue from Artemis Company.

13. The formulation as described in claim 12 wherein the pigment is a noble or rare earth metal in the colloidal state or as nanoparticles.

14. The formulation as described in claim 4 where the marker is a water-insoluble fluorescent agent in the form of a polymer or plastic, selected from the class of organic dyes dissolved in organic polymeric resins including AIT-4466 Invisible Yellow, D034 Yellow, IPO-13 red, IPO-15 orange, IPO-18 green and IPO-19 blue; PF-00 invisible blue, PF-01 invisible orange, PF-RT invisible red, PF-07 invisible blue-white, PF-08 invisible bright white, PF-09 invisible violet from Risk Reactor; PSP, MDP and MTC series of dyes from Spectra System Corp.

15. The formulation as described in claim 4 wherein the marker is a phosphorescent non-skin staining dye.

16. The formulation as described in claim 15 wherein the marker is an organic molecule having at least one carbon ring functional as a dye intermediate.

17. The formulation as described in claim 16 wherein the organic molecule has between two and six carbon rings, which functions as a dye intermediate.

18. The formulation as described in claim 4 wherein the marker is selected from the group consisting of coumarinic compounds, stilbene and its derivatives, pyrene and its derivatives, anthracenes, tetracenes, pentracenes, quinolines, quinones, aryl methanes, naphthacenes, fluoresceins, anilines, thiazoles, oxazoles, pyranines, carbazoles, rhodamines, dansylated compounds, propidiums, biotin derivatives, ethidiums, cyanines, uranines, benzoxazoles, benzothizaoles, succimidyl compounds dialdehydes, quinoids.

19. The formulation of claim 1 wherein the detectability of the marker is substantially increased when released from the binder.

20. A hand cleansing and use verification formulation comprising:
a) a cleansing compound capable of removing, destroying, neutralizing or inhibiting the growth of pathogenic microorganisms on a person's hands through a hand scrubbing action; and
b) a fluorescent/phosphorescent marker agent aggregated with a non-fluorescent/phosphorescent binder, the aggregates being arranged to be broken up releasing the marker when subjected to vigorous scrubbing action between a user's hands bearing the formulation, the marker having the characteristics of substantially increasing its visible detectability when released from the binder and subjected to stimulating radiations.

21. A method of verifying that a hand washing protocol meets a preset standard of hand hygiene comprising:
a) dispensing a quantity of the cleansing formulation of claims 1, 2, 3, 4, 5, 6, 7, 8, 9, 10, 11, 12, 13, 14, 15, 16, 17, 18, 19 or 20 onto a person's hands;
b) subsequently obtaining a quantitative measurement of the light emitted from the person's hands following a scrubbing action between the hands with the formulation thereon;
c) determining whether or not the measured quantity exceeds a preset amount indicative that the standard has been met.

22. The method of claim 21 including the step of advising the person to scrub his/her hands together after the formulation has been dispensed before the measurement is made.

23. The method of claim 22 further including the step of advising the person that he/she must repeat the scrubbing step in the event that measured quantity of light is below the preset amount.
